(19) United States
(12) Patent Application Publication
(10) Pub. No.: US 2012/0227770 A1
(43) Pub. Date: Sep. 13, 2012

(54) TWO-FLUID NOZZLE, SUBSTRATE LIQUID PROCESSING APPARATUS, SUBSTRATE LIQUID PROCESSING METHOD, AND COMPUTER-READABLE STORAGE MEDIUM FOR STORING SUBSTRATE LIQUID PROCESSING METHOD

(75) Inventors: Satoshi Kaneko, Koshi City (JP); Yoshihiro Kai, Koshi City (JP)

(73) Assignee: TOKYO ELECTRON LIMITED, Tokyo (JP)

(21) Appl. No.: 13/413,788

(22) Filed: Mar. 7, 2012

(30) Foreign Application Priority Data
Mar. 9, 2011 (JP) 2011-050958

(51) Int. Cl. B08B 3/02; B08B 5/00; B08B 3/04

(52) U.S. Cl. 134/36; 134/102.1

(57) ABSTRACT

There are provided a two-fluid nozzle for effectively performing a liquid process on a substrate while suppressing a damage on the substrate, and a substrate liquid processing apparatus, a substrate liquid processing method and a storage medium using the two-fluid nozzle. The two-fluid nozzle includes a first liquid discharge hole for discharging a first liquid and a gas discharge hole for discharging a gas, and discharges, toward a target object, a mixed fluid of the first liquid discharged from the first liquid discharge hole and the gas discharged from the gas discharge hole. The mixed fluid is mixed at an outside of the two-fluid nozzle. The two-fluid nozzle further includes a second liquid discharge hole for supplying a second liquid toward an outer periphery of a target spot on the target object or toward an inner side of the outer periphery of the target spot.

### CROSS-REFERENCE TO RELATED APPLICATION

This application claims the benefit of Japanese Patent Application No. 2011-050958 filed on Mar. 9, 2011, the entire disclosures of which are incorporated herein by reference.

### FIELD OF THE INVENTION

The present disclosure relates to a two-fluid nozzle that sprays mixed fluid, which is generated by mixing discharged liquid and gas at an outside of the two-fluid nozzle, a substrate liquid processing apparatus including the two-fluid nozzle, a substrate processing method using the two-fluid nozzle, and a computer-readable storage medium for storing a substrate liquid processing program using the two-fluid nozzle.

### BACKGROUND OF THE INVENTION

Conventionally, in order to manufacture a semiconductor component or a flat panel display, a cleaning process is performed on a substrate such as a semiconductor wafer and a liquid crystal substrate by using a substrate liquid processing apparatus with a cleaning solution, and then a drying process for drying the substrate is performed.

In the substrate liquid processing apparatus, in order to effectively clean a surface of the substrate by spraying the cleaning solution on the surface of the substrate, a mixed fluid of the cleaning solution and an injection gas is sprayed on the substrate by using a two-fluid nozzle.

This two-fluid nozzle includes a liquid discharge opening for discharging the cleaning solution and a gas discharge opening for discharging the injection gas. The cleaning solution discharged from the liquid discharge opening and the injection gas discharged from the gas discharge opening are mixed at an outside of the two-fluid nozzle, and the two-fluid nozzle is configured to spray the mixed fluid in the mist form on the surface of the substrate (see, for example, Patent Document 1).

Patent Document 1: Japanese Patent Laid-open Publication No. 2005-288390

The conventional two-fluid nozzle sprays the mixed fluid in the mist form on the substrate, so that a liquid film of the cleaning solution is formed on the surface of the substrate. However, at an outer periphery of the mixed fluid sprayed on the substrate, a discharge pressure of the injection gas is high. As a result, a thickness of the liquid film formed on the surface of the substrate where the mixed fluid is sprayed becomes decreased.

For this reason, in a substrate liquid process using the conventional two-fluid nozzle, on the surface of the substrate where the mixed fluid is sprayed, there may be generated a damage, such as collapse of a circuit pattern or the like formed on the surface of the substrate, due to the discharge pressure of the injection gas.

### BRIEF SUMMARY OF THE INVENTION

In view of the foregoing, in accordance with one aspect of an illustrative embodiment, there is provided a two-fluid nozzle. The two-fluid nozzle includes a first liquid discharge hole for discharging a first liquid; and a gas discharge hole for discharging a gas, and discharging toward a target spot on a target object a mixed fluid of the first liquid discharged from the first liquid discharge hole and the gas discharged from the gas discharge hole. Here, the mixed fluid is mixed at an outside of the two-fluid nozzle. The two-fluid nozzle further includes a second liquid discharge hole for supplying a second liquid toward an outer periphery of the target spot on the target object or toward an inner side of outer periphery of the target spot.

The second liquid discharge hole may supply the second liquid toward the outer periphery of the target spot on the target object.

The two-fluid nozzle further may include a first liquid supply path connected to the first liquid discharge hole; and a second liquid supply path connected to the second liquid discharge hole and provided separately from the first liquid supply path. Each of the first and second liquid supply paths may include a flow rate controller.

In accordance with another aspect of an illustrative embodiment, there is provided a substrate liquid processing apparatus for performing a liquid process on a substrate by using a two-fluid nozzle that includes a first liquid discharge hole for discharging a first liquid and a gas discharge hole for discharging a gas, and that is configured to mix the first liquid discharged from the first liquid discharge hole and the gas discharged from the gas discharge hole at an outside of the two-fluid nozzle to generate a mixed fluid and to discharge the mixed fluid toward a target spot on the substrate. The two-fluid nozzle may further include a second liquid discharge hole for supplying a second liquid toward an outer periphery of the target spot on the substrate or toward an inner side of the outer periphery of the target spot.

The second liquid discharge hole may supply the second liquid toward the outer periphery of the target spot on the substrate.

The two-fluid nozzle may further include a first liquid supply path connected to the first liquid discharge hole; and a second liquid supply path connected to the second liquid discharge hole and provided separately from the first liquid supply path. Each of the first and second liquid supply paths may include a flow rate controller.

After the second liquid is discharged from the second liquid discharge hole, the first liquid and the gas may be discharged from the first liquid discharge hole and the gas discharge hole, respectively.

The second liquid may be discharged at a flow rate capable of preventing disturbance of a flow of the mixed fluid.

In accordance with still another aspect of an illustrative embodiment, there is provided a substrate liquid processing method for performing a liquid process on a substrate by using a two-fluid nozzle that discharges a first liquid and a gas, mixes the discharged first liquid and the discharged gas at an outside of the two-fluid nozzle to generate a mixed fluid, and discharges the mixed fluid toward a target spot on the substrate. Here, a second liquid may be supplied toward an outer periphery of the target spot on the substrate or toward an inner side of the outer periphery of the target spot.

The second liquid may be supplied toward the outer periphery of the target spot on the substrate.

After the second liquid may be discharged on the substrate, the mixed fluid may be discharged on the substrate.

Flow rates of the first liquid and the second liquid may be controlled independently.

The second liquid may be discharged at a flow rate capable of preventing disturbance of a flow of the mixed fluid.

In accordance with still another aspect of an illustrative embodiment, there is a computer-readable storage medium having stored thereon computer-readable instructions that, in response to execution, cause a substrate liquid processing apparatus to perform a substrate liquid processing method for carrying out a liquid process on a substrate by using a two-fluid nozzle that discharges a first liquid and a gas. The substrate liquid processing method includes mixing the discharged first liquid and the discharged gas at an outside of the two-fluid nozzle to generate a mixed fluid and discharging the mixed fluid toward a target spot on the substrate; supplying a second liquid toward an outer periphery of the target spot on the substrate; and moving a discharging position of the mixed fluid and a supplying position of the second liquid.

In accordance with an illustrative embodiment, a second liquid is supplied toward an outer periphery of a target spot on the target object (on the substrate). As a result, it is possible to prevent a liquid film from being thinned at the outer periphery of the target spot on the target object (on the substrate), and further, suppress damage on a surface of the target object.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a plane view of a substrate liquid processing apparatus;

FIG. 2 is a schematic diagram of a substrate processing chamber;

FIG. 3 is a front cross sectional view of a two-fluid nozzle;

FIG. 4 is a bottom view of a two-fluid nozzle;

FIG. 5 is an A-A cross sectional view of a two-fluid nozzle;

FIG. 6 is an explanatory diagram of a substrate liquid processing method (a substrate liquid processing program);

FIG. 7 is an explanatory diagram showing an operation (a substrate receiving process) of a substrate processing chamber;

FIG. 8 is an explanatory diagram showing an operation (a rinse process) of a substrate processing chamber;

FIG. 9 is an explanatory diagram showing an operation (a second liquid supplying process) of a substrate processing chamber;

FIG. 10 is an explanatory diagram showing an operation (a mixed fluid spraying process) of a substrate processing chamber;

FIG. 11 is an explanatory diagram showing a discharging type of a second liquid; and

FIG. 12 is an explanatory diagram showing an operation (a substrate transfer process) of a substrate processing chamber.

### DETAILED DESCRIPTION OF THE INVENTION

Hereinafter, a two-fluid nozzle, a substrate liquid processing apparatus including the two-fluid nozzle, a substrate liquid processing method using the two-fluid nozzle, and a substrate liquid processing program in accordance with illustrative embodiments will be described in detail with reference to the accompanying drawings.

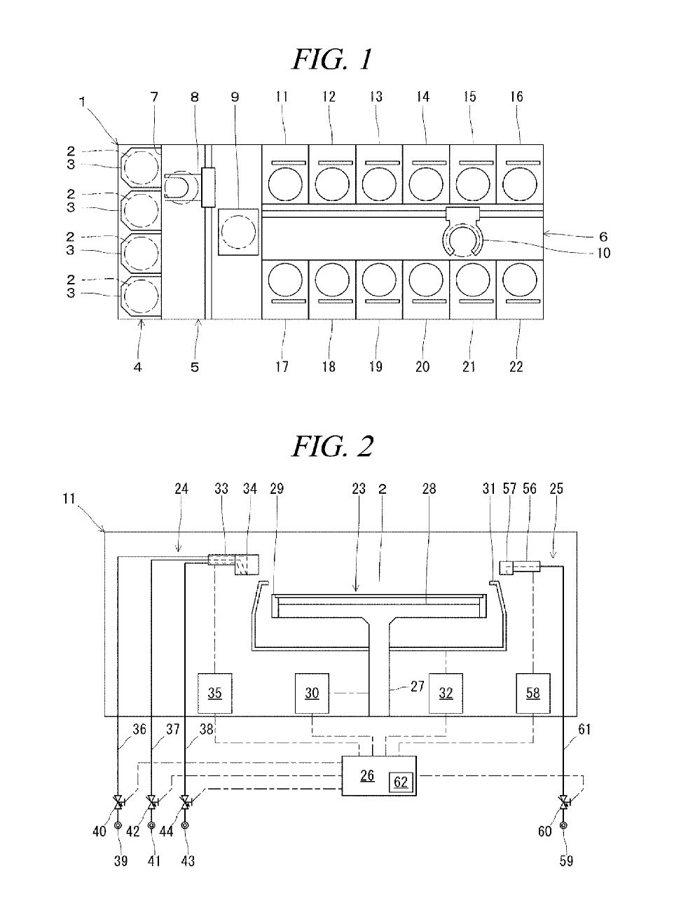

As depicted in FIG. 1, a substrate liquid processing apparatus 1 includes a substrate loading/unloading section 4; a substrate transfer section 5; and a substrate processing section 6. The substrate loading/unloading section 4 is configured to load and unload a multiple number of, for example, 25, substrates 2 (herein, semiconductor wafers) as target objects to and from a carrier 3 at a front end portion of a substrate liquid processing apparatus 1. Further, the substrate transfer section 5 is arranged at the rear of the substrate loading/unloading section 4 and configured to transfer the substrates 2 accommodated in the carrier 3. Furthermore, the substrate processing section 6 is arranged at the rear of the substrate transfer section 5 and configured to perform various processes, such as a cleaning process and a drying process, on the substrates 2.

The substrate loading/unloading section 4 is configured to place the four carriers 3 at regular intervals in left and right directions while the four carriers 3 are in close contact with a front wall 7 of the substrate transfer section 5.

The substrate transfer section 5 includes a substrate transfer device 8 and a substrate transfer table 9 therein and is configured to transfer the substrates 2 between any one of the carriers placed in the substrate loading/unloading section 4 and the substrate transfer table 9 by using the substrate transfer device 8.

The substrate processing section 6 includes a substrate transfer device 10 at a central portion thereof and substrate processing chambers 11 to 22 arranged back and forth at left and right sides of the substrate transfer device 10.

Further, the substrate processing section 6 is configured to transfer each of the substrates 2 between the substrate transfer table 9 of the substrate transfer section 5 and each of the substrate processing chambers 11 to 22 by using the substrate transfer device 10. Then, each of the substrates 2 is processed in each of the substrate processing chambers 11 to 22.

The substrate processing chambers 11 to 22 have the same configuration, and, thus, a configuration of the substrate processing chamber 11 will be explained as a representative example. As depicted in FIG. 2, the substrate processing chamber 11 includes a substrate holding unit 23 configured to horizontally hold and rotate the substrate 2; a cleaning solution discharge unit 24 configured to discharge a cleaning solution toward an upper surface of the substrate 2 held by the substrate holding unit 23; and a rinse discharge unit 25 configured to discharge a rinse toward the upper surface of the substrate held by the substrate holding unit 23. The substrate holding unit 23, the cleaning solution discharge unit 24, and the rinse discharge unit 25 are controlled by a control unit 26. Further, the control unit 26 controls the whole substrate liquid processing apparatus 1 including the substrate transfer devices 8 and 10.

In the substrate holding unit 23, a circular plate-shaped table 28 is horizontally provided on an upper end of a rotation shaft 27, and a multiple number of substrate holding members 29 for horizontally holding the substrate 2 are provided at a periphery of the table 28 at regular intervals along a circumference thereof. The substrate holding members 29 are in contact with a periphery of the substrate 2. The rotation shaft 27 is connected to a rotation driving device 30. The rotation shaft 27 and the table 28 are rotated by the rotation driving device 30, so that the substrate 2 held by the substrate holding members 29 on the table 28 is also rotated. The rotation driving device 30 is connected to the control unit 26, and its rotation is controlled by the control unit 26.

Around the substrate holding unit 23, a cup 31 having an upper opening is provided so as to be vertically movable. The cup 31 surrounds the substrate 2 mounted on the table 28 so as to prevent the cleaning solution or the rinse from being dispersed. Further, the cup 31 collects the cleaning solution or the rinse. The cup 31 is connected to an elevating device 32, and the elevating device 32 moves the cup 31 up and down relatively with respect to the substrate 2. The elevating device 32 is connected to the control unit 26 and the elevation thereof is controlled by the control unit 26.

In the cleaning solution discharge unit 24, an arm 33 is positioned above the table 28 so as to be horizontally movable, and a two-fluid nozzle 34 serving as a cleaning solution discharge nozzle is provided at a front end of the arm 33. The arm 33 is connected to a moving device 35. The two-fluid nozzle 34 is horizontally moved between a retreated position outside the substrate 2 and a starting position above a central area of the substrate 2 by the moving device 35. The moving device 35 is connected to the control unit 26 and the movement thereof is controlled by the control unit 26. Further, the two-fluid nozzle 34 is configured to spray, toward the substrate 2, a mixed fluid, which is generated by mixing a cleaning solution as a first liquid and an injection gas at an outside of the two-fluid nozzle 34. Moreover, the two-fluid nozzle 34 is configured to supply a second liquid toward an outer periphery of a target spot on the substrate 2. Here, the target spot indicates an area where the mixed fluid exists when the mixed fluid sprayed from the two-fluid nozzle 34 reaches the substrate 2 (hereinafter, referred to as “target spot”).

The cleaning solution discharge unit 24 includes a first liquid supply path 36 for supplying the cleaning solution as the first liquid to the two-fluid nozzle 34; a gas supply path 37 for supplying the injection gas to the two-fluid nozzle 34; and a second liquid supply path 38 for supplying the second liquid to the two-fluid nozzle 34.

The first liquid supply path 36 is connected to a first liquid supply source 39 for supplying the first liquid (cleaning solution) via a flow rate controller 40. A flow rate of the cleaning solution to be supplied to the two-fluid nozzle 34 is controlled by the flow rate controller 40. The flow rate controller 40 is connected to the control unit 26, and the control unit 26 carries out an opening/closing control and a flow rate control.

The gas supply path 37 is connected to a gas supply source 41 for supplying the gas (injection gas) via a flow rate controller 42. A flow rate of the injection gas to be supplied to the two-fluid nozzle 34 is controlled by the flow rate controller 42. The flow rate controller 42 is connected to the control unit 26, and the control unit 26 carries out an opening/closing control and a flow rate control.

The second liquid supply path 38 is connected to a second liquid supply source 43 for supplying the second liquid via a flow rate controller 44. A flow rate of the second liquid to be supplied to the two-fluid nozzle 34 is controlled by the flow rate controller 44. The flow rate controller 44 is connected to the control unit 26, and the control unit 26 carries out an opening/closing control and a flow rate control. The second liquid may be the same kind of liquid as the first liquid. If the second liquid is the same kind of liquid having the same concentration as the first liquid, even if the second liquid is supplied, a concentration of the first liquid may not be changed on the surface of the substrate 2. Further, the second liquid may be a mixture of SC-1 and pure water, which is a different kind of liquid from the first liquid.

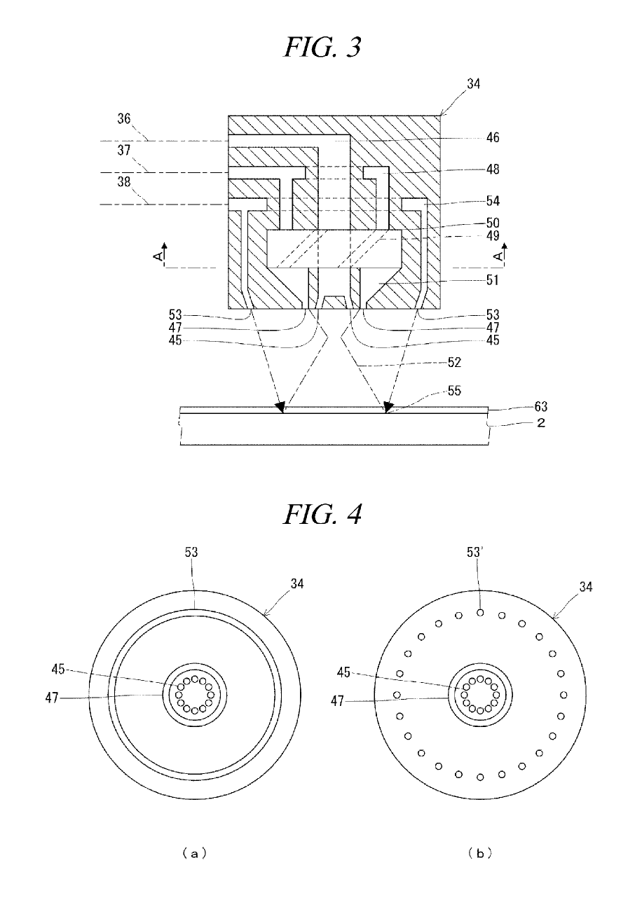

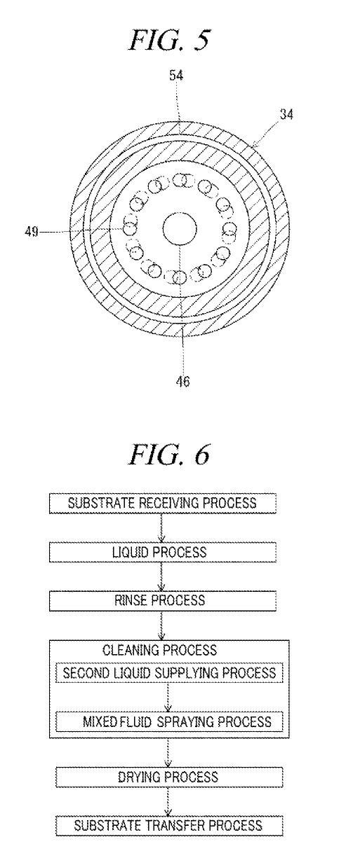

The two-fluid nozzle 34 includes, as first liquid discharge holes 45 for discharging a first liquid, a multiple number of (herein, 12) circular holes at a central area of a lower end surface (front end surface) as depicted in FIGS. 3 to 5. These first liquid discharge holes 45 are arranged so as to have a circle shape, and each of the first liquid discharge holes 45 is formed so as to be slightly inclined toward an outer periphery of the two-fluid nozzle 34. Further, the two-fluid nozzle 34 includes therein a first liquid communication path 46 that communicates with the first liquid discharge holes 45, and the first liquid communication path 46 is connected to the first liquid supply path 36. Thus, the two-fluid nozzle 34 can discharge the first liquid supplied from the first liquid supply path 36 while diffusing the first liquid outwards from the first liquid discharge holes 45 toward the substrate 2.

The two-fluid nozzle 34 includes, as a gas discharge hole 47 for discharging a gas, a circular ring-shaped hole having a slit shape. The gas discharge hole 47 is formed outside the first liquid discharge holes 45 so as to be arranged concentrically with the circle formed by the first liquid discharge holes 45. Further, the two-fluid nozzle 34 includes therein a gas communication path 48 that communicates with the gas discharge hole 47. The gas communication path 48 is connected to the gas supply path 37. The gas communication path 48 includes a vortex flow generation unit 50 having a multiple number of (herein, 12) vortex paths 49 that are inclined from an upper stream side (upper surface side) to a downstream side (lower surface side) while being rotated in a clockwise direction (in a right direction) when viewed from the top. Further, the gas communication path 48 includes an inclined path 51 inclined from the upper stream side to the downstream side toward an inner periphery of the two-fluid nozzle 34. Thus, the two-fluid nozzle 34 discharges the gas supplied from the gas supply path 37 toward the substrate 2 through the gas discharge hole 47 while revolving the gas toward the inner periphery of the two-fluid nozzle 34. The two-fluid nozzle 34 injects the gas discharged from the gas discharge hole 47 to the first liquid discharged from the first liquid discharge holes 45. Therefore, the first liquid and the gas are mixed at the outside (below) of a front end of the two-fluid nozzle 34, and liquid droplets of the first liquid are generated. Then, a mixed fluid where the liquid droplets are diffused is sprayed on the surface of the substrate 2.

The two-fluid nozzle 34 includes, as a second liquid discharge hole 53 for discharging a second liquid, a circular ring-shaped hole having a slit shape. The second liquid discharge hole 53 is formed outside the gas discharge hole 47 of the lower end surface (front end surface) so as to be arranged concentrically with the gas discharge hole 47. Further, the two-fluid nozzle 34 includes therein a second liquid communication path 54 that communicates with the second liquid discharge hole 53. The second liquid communication path 54 is slightly inclined toward the second liquid discharge hole 53 and toward the center of the two-fluid nozzle 34. The second liquid communication path 54 is connected to the second liquid supply path 38. Since the second liquid communication path 54 is inclined toward the center of the two-fluid nozzle 34, the second liquid supplied from the second liquid discharge hole 53 is discharged toward an outer periphery 55 of the target spot on the surface of the substrate 2 or the inner side thereof. The two-fluid nozzle 34 may include, as second liquid discharge holes 53′, a multiple number of (herein, 24) circular holes formed outside the gas discharge hole 47 on the lower end surface (front end surface) of the two-fluid nozzle 34. The second liquid discharge holes 53′ are arranged so as to have a circle shape, and the circle formed by the second liquid discharge holes 53′ is concentric with the gas discharge hole 47 as depicted in FIG. 4(b). The two-fluid nozzle 34 may include the second liquid discharge holes 53 and 53′ together with the first liquid discharge holes 45 and the gas discharge hole 47 as a single unit. Further, the two-fluid nozzle 34 may include a second liquid discharge hole formed at a member provided separately from the two-liquid nozzle 34. Further, in the two-fluid nozzle 34, the first liquid supply path 36 and the flow rate controller 40 may be provided separately from the second liquid supply path 38 and the flow rate controller 44, so that a first liquid and a second liquid of different kinds from each other can be used, and a flow rate and discharge timing can be controlled independently. Otherwise, these components may be integrated with each other to simplify a configuration.

The rinse discharge unit 25 is provided above the table 28 so as to horizontally move an arm 56, and a rinse discharge nozzle 57 is provided at a front end of the arm 56 as depicted in FIG. 2. The arm 56 is connected to a moving device 58 and the rinse discharge nozzle 57 is moved between a retreated position outside the substrate 2 and a starting position straightly above the central area of the substrate by the moving device 58. The moving device 58 is connected to the control unit 26, and the movement thereof is controlled by the control unit 26.

The rinse discharge unit 25 connects a rinse supply source 59 for supplying a rinse to the rinse discharge nozzle 57 via a flow rate controller 60 and a rinse supply path 61. A flow rate of the rinse to be supplied to the rinse discharge nozzle 57 is controlled by the flow rate controller 60. The flow rate controller 60 is connected to the control unit 26, and the control unit 26 carries out an opening/closing control and a flow rate control.

The substrate liquid processing apparatus 1 is configured as described above, and processes the substrate 2 in each of the substrate processing chambers 11 to 22 according to a substrate liquid processing program stored in a storage medium 62 which can be read out by the control unit 26 (computer). The storage medium 62 may store various programs such as a substrate liquid processing program, and may include a semiconductor memory-type storage medium, such as a ROM or a RAM, or a disk-type storage medium, such as a hard disk or a CD-ROM.

The substrate liquid processing apparatus 1 processes the substrate 2 according to a substrate liquid processing program as depicted in FIG. 6 and described below.

According to the substrate liquid processing program, as depicted in FIG. 6, a substrate receiving process is performed. In the substrate receiving process, the substrate 2 loaded into each of the substrate processing chambers 11 to 22 by the substrate transfer device 10 is received by the substrate holding unit 23.

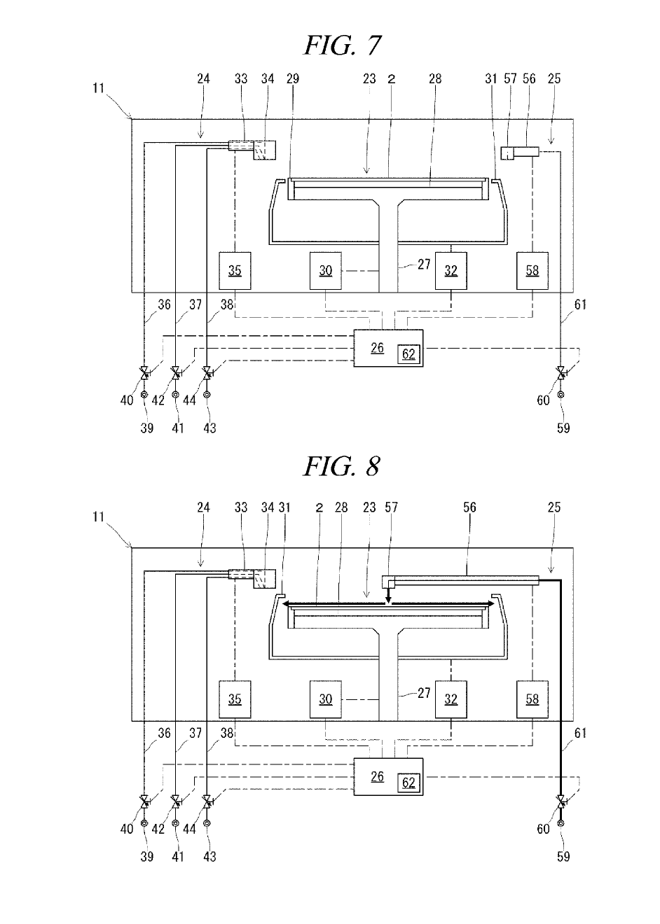

In this substrate receiving process, as depicted in FIG. 7, the elevating device 32 of the substrate holding unit 23 is controlled by the control unit 26 in the substrate processing chamber 11, so that the cup 31 is lowered to a certain position. Then, the substrate holding members 29 receive the substrate 2 from the substrate transfer device 10 and support the substrate 2. Thereafter, the elevating device 32 of the substrate holding unit 23 is controlled by the control unit 26, so that the cup 31 is raised to a certain position.

Subsequently, as depicted in FIG. 6, a liquid process is performed. In the liquid process, the substrate 2 received in the substrate receiving process is processed with various processing liquids. This liquid process may be performed by using a non-illustrated chemical liquid nozzle and a publicly-known chemical liquid.

Then, as depicted in FIG. 6, a rinse process is performed. In the rinse process, a rinse is supplied to the substrate 2 processed in the liquid process, and the processing liquids on the substrate 2 are rinsed and removed.

In this rinse process, as depicted in FIG. 8, the rotation driving device 30 is controlled by the control unit 26 in the substrate processing chamber 11, so that the table 28 of the substrate holding unit 23 and the substrate 2 held by the substrate holding members 29 are rotated at a certain rotation speed. The moving device 58 is controlled by the control unit 26, so that the rinse discharge nozzle 57 of the rinse discharge unit 25 is moved to a rinse supply starting position above the central area of the substrate 2. If the rinse discharge nozzle 57 is moved to the rinse supply starting position, the flow rate controller 60 is opened by the control unit 26 and a flow rate of the rinse is controlled. Thus, the rinse supplied from the rinse supply source 59 is discharged toward the surface of the substrate 2 through the rinse discharge nozzle 57 for a certain time. Then, the flow rate controller 60 is closed by the control unit 26, the discharge of the rinse through the rinse discharge nozzle 57 is stopped. After the discharge of the rinse is stopped, the moving device 58 is controlled by the control unit 26, so that the rinse discharge nozzle 57 of the rinse discharge unit 25 is moved to the retreated position outside an outer periphery of the substrate 2.

Thereafter, as depicted in FIG. 6, a cleaning process is performed. In the cleaning process, the substrate 2 processed in the rinse process is cleaned with a cleaning solution. In the cleaning process, a second liquid supplying process for supplying only a second liquid through the two-fluid nozzle 34 is performed, and a first liquid and a gas discharged from the two-fluid nozzle 34 are mixed at the outside while the second liquid is being supplied. Then, a mixed fluid spraying process for spraying a mixed fluid is performed.

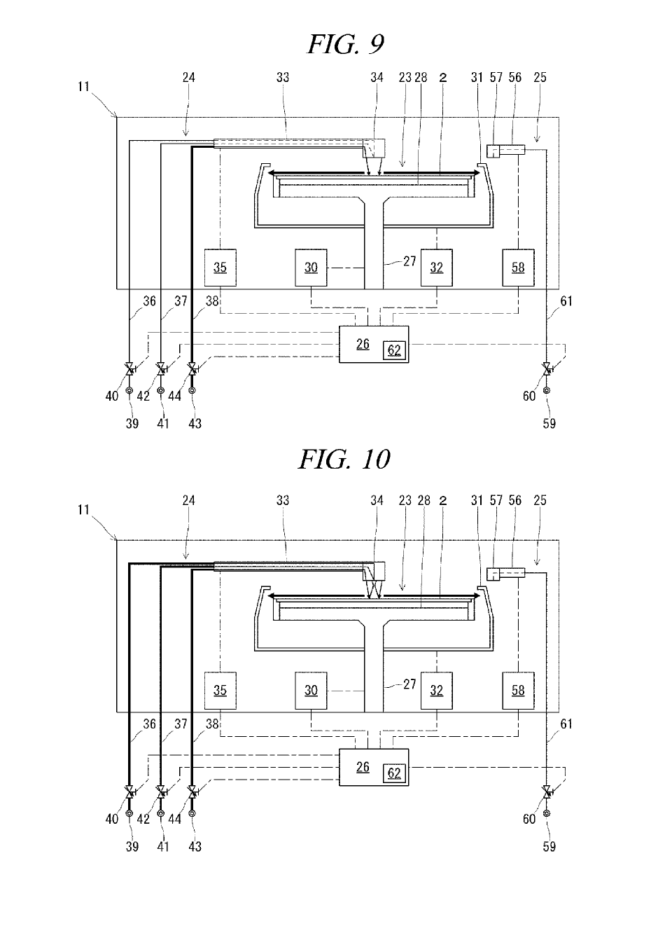

In the second liquid supplying process, as depicted in FIG. 9, the rotation driving device 30 is controlled by the control unit 26 in the substrate processing chamber 11, so that the table 28 of the substrate holding unit 23 and the substrate 2 held by the substrate holding members 29 are rotated at a certain rotation speed. The moving device 35 is controlled by the control unit 26, so that the two-fluid nozzle 34 of the cleaning solution discharge unit 24 is moved to the cleaning solution supply starting position above the central area of the substrate 2. If the two-fluid nozzle 34 is moved to the cleaning solution supply starting position, the flow rate controller 44 is opened by the control unit 26, and a flow rate of the cleaning solution is controlled. Thus, the second liquid supplied from the second liquid supply source 43 is discharged toward the surface of the substrate 2 through the second liquid discharge hole 53 of the two-fluid nozzle 34. As a result, in addition to the rinse remaining on the substrate 2, the second liquid is supplied on the substrate 2, so that a liquid film 63 having a certain film thickness is formed on the upper surface of the substrate 2. The film thickness of the liquid film 63 is set to suffer damage, such as collapse of a circuit pattern or the like formed on the upper surface of the substrate 2 by a discharge pressure of the mixed fluid discharged through the two-fluid nozzle 34. Further, the film thickness of the liquid film 63 is set to allow the discharge pressure to affect particles on the upper surface of the substrate 2.

In the mixed fluid spraying process, as depicted in FIG. 10, while the table 28 of the substrate holding unit 23 and the substrate 2 held by the substrate holding members 29 are rotated at a certain rotation speed and the second liquid is discharged toward the upper surface of the substrate 2 from the second liquid discharge hole 53 in the substrate processing chamber 11, the flow rate controllers and 42 are opened by the control unit 26 and the flow rates are controlled. Thus, the first liquid supplied from the first liquid supply source 39 and the gas supplied from the gas supply source 41 are discharged toward the upper surface of the substrate 2 from the first liquid discharge holes 45 and the gas discharge hole 47 of the two-fluid nozzle 34, respectively. Then, the first liquid discharged from the first liquid discharge holes 45 and the gas discharged from the gas discharge hole 47 are mixed at the outside and below of the front end of the two-fluid nozzle so as to generate a mixed fluid. The mixed fluid is sprayed on the substrate 2. Thereafter, the moving device 35 is controlled by the control unit 26, so that the arm 33 is horizontally moved. Thus, the two-fluid nozzle 34 can be moved between above the central area of the substrate 2 and above the outer periphery of the substrate 2 to clean the substrate 2. If the cleaning process is ended, the flow rate controllers 40, 42, and 44 are closed by the control unit 26, so that the discharge of the first and second liquids and the gas through the two-fluid nozzle 34 is stopped. Then, the moving device 35 is controlled by the control unit 26, so that the two-fluid nozzle 34 of the cleaning solution discharge unit 24 is moved to the retreated position outside the outer periphery of the substrate 2. The two-fluid nozzle 34 may be moved between above the central area and above the outer periphery of the substrate 2 just one time or a multiple number of times.

As described above, according to the substrate liquid processing program, the substrate 2 is cleaned by supplying the second liquid to the outer periphery of the target spot on the substrate 2.

In order to prevent the pattern formed on the upper surface of the substrate 2 from being damaged, for example, from being collapsed, it is desirable to spray the mixed fluid on the area where the liquid film 63 is formed on the upper surface of the substrate 2. However, if only the mixed fluid is sprayed thereon, a film thickness of the liquid film 63 may be thinned at the outer periphery of the target spot on the upper surface of the substrate 2 by a discharge pressure of the gas discharged from the gas discharge hole 47. Accordingly, in accordance with the illustrative embodiment of the substrate liquid processing program, the second liquid is supplied from the second liquid discharge hole 53 to the outer periphery of the target spot on the substrate 2. Thus, it is possible to prevent the liquid film 63 from being thinned at the outer periphery of the target spot on the surface of the substrate 2. Particularly, since the mixed fluid spraying process is performed after the second liquid supplying process, a liquid film of the rinse and the second liquid is formed on the surface of the substrate 2 on which the mixed fluid is already sprayed. Thus, before the mixed fluid is sprayed, it is possible to form the liquid film having a thickness which is sufficient to prevent damage such as collapse of the pattern and to obtain an effectively cleaning effect. Therefore, the liquid film does not become thinned right after the mixed fluid is sprayed, so that it is possible to prevent the pattern from being damaged, for example, from being collapsed. Further, the second liquid is discharged at a flow rate that does not disturb a flow of the mixed fluid, so that a cleaning effect caused by spraying the mixed fluid is not reduced.

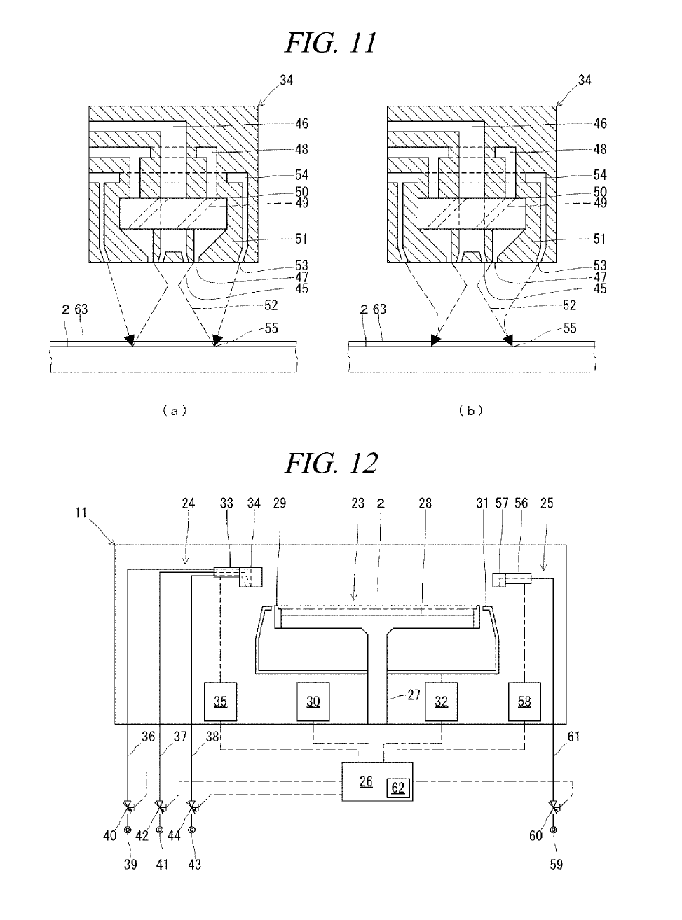

The second liquid is supplied so as to reach the outer periphery of the target spot on the surface of the substrate. As depicted in FIG. 11(a), it is not necessary to directly discharge, from the second liquid discharge hole 53, the second liquid toward the outer periphery of the target spot on the surface of the substrate 2. As depicted in FIG. 11(b), the second liquid may be discharged from the second liquid discharge hole 53 toward the inner side of the outer periphery of the target spot on the substrate 2, and then sprayed to the outer periphery of the target spot on the substrate by the gas discharged from the gas discharge hole 47. In this case, the second liquid flows along an outer periphery of the gas that forms a vortex flow, and then, the second liquid is supplied to the outer periphery of the target spot on the surface of the substrate. At that time, the second liquid collides with the gas, so that a pressure of the gas on the surface of the substrate 2 is reduced. Thus, it is possible to prevent the liquid film 63 from being thinned and also possible to prevent damage such as collapse of the pattern.

In the cleaning process, the control unit 26 separately controls the flow rate controllers 40 and 44 of the first and second liquid supply paths 36 and 38 or the flow rate controller 42 of the gas supply path 37 based on the substrate liquid processing program. Thus, a first liquid and a second liquid of different kinds from each other can be used, and a flow rate and discharge timing can be controlled independently. Therefore, it is possible to form a liquid film having a film thickness depending on a discharge pressure of the gas.

Then, according to the substrate liquid processing program, as depicted in FIG. 6, a drying process is performed. In the drying process, the substrate 2 cleaned in the cleaning process is dried.

In the drying process, the rotation driving device 30 is controlled by the control unit 26 in the substrate processing chamber 11, so that the table 28 of the substrate holding unit 23 and the substrate 2 held by the substrate holding members 29 are rotated at a rotation speed greater than other rotation speeds of the liquid processes (the cleaning process and the rinse process). Thus, the rinse is removed from the upper surface of the substrate 2 by centrifugal force, and the substrate 2 is dried.

Finally, according to the substrate liquid processing program, as depicted in FIG. 6, a substrate transfer process is performed. In the substrate transfer process, the substrate 2 is transferred from the substrate holding unit 23 in each of the substrate processing chambers 11 to 22 to the substrate transfer device 10.

In the substrate transfer process, as depicted in FIG. 12, the elevating device 32 of the substrate holding unit 23 is controlled by the control unit 26 in the substrate processing chamber 11, so that the cup 31 is lowered to a certain position. Then, the substrate 2 supported by the substrate holding members 29 is transferred to the substrate transfer device 10 and unloaded from the substrate processing chamber 11. Thereafter, the elevating device 32 of the substrate holding unit 23 is controlled by the control unit 26 in the substrate processing chamber 11, so that the cup 31 is raised to a certain position. The substrate transfer process may be performed simultaneously with the substrate receiving process.

As described above, in the substrate liquid processing apparatus 1, the liquid process (cleaning process) is performed on the substrate 2 by supplying the second liquid to the outer periphery of the target spot on the surface of the substrate 2 (target object).

For this reason, in the substrate liquid process performed by the substrate liquid processing apparatus 1, the second liquid is supplied from the second liquid discharge hole 53 to the outer periphery of the target spot on the surface of the substrate 2. As a result, it is possible to prevent the liquid film 63 from being thinned at the outer periphery of the target spot on the surface of the substrate 2. Therefore, it is possible to prevent the circuit pattern formed on the surface of the substrate 2 from being damaged, for example, from being collapsed, and the liquid process (cleaning process) can be effectively performed on the substrate 2.

What is claimed is:

1. A two-fluid nozzle having a first liquid discharge hole for discharging a first liquid and a gas discharge hole for discharging a gas, and discharging toward a target spot on a target object a mixed fluid of the first liquid discharged from the first liquid discharge hole and the gas discharged from the gas discharge hole, the mixed fluid being mixed at an outside of the two-fluid nozzle, the two-fluid nozzle comprising:
a second liquid discharge hole for supplying a second liquid toward an outer periphery of the target spot on the target object or toward an inner side of the outer periphery of the target spot.

2. The two-fluid nozzle of claim 1,
wherein the second liquid discharge hole supplies the second liquid toward the outer periphery of the target spot on the target object.

3. The two-fluid nozzle of claim 1, further comprising:
a first liquid supply path connected to the first liquid discharge hole; and
a second liquid supply path connected to the second liquid discharge hole and provided separately from the first liquid supply path,
wherein each of the first and second liquid supply paths includes a flow rate controller.

4. A substrate liquid processing apparatus for performing a liquid process on a substrate by using a two-fluid nozzle that includes a first liquid discharge hole for discharging a first liquid and a gas discharge hole for discharging a gas, and that is configured to mix the first liquid discharged from the first liquid discharge hole and the gas discharged from the gas discharge hole at an outside of the two-fluid nozzle to generate a mixed fluid and to discharge the mixed fluid toward a target spot on the substrate,
wherein the two-fluid nozzle further includes a second liquid discharge hole for supplying a second liquid toward an outer periphery of the target spot on the substrate or toward an inner side of the outer periphery of the target spot.

5. The substrate liquid processing apparatus of claim 4,
wherein the second liquid discharge hole supplies the second liquid toward the outer periphery of the target spot on the substrate.

6. The substrate liquid processing apparatus of claim 4,
wherein the two-fluid nozzle further includes:
a first liquid supply path connected to the first liquid discharge hole; and
a second liquid supply path connected to the second liquid discharge hole and provided separately from the first liquid supply path, and
each of the first and second liquid supply paths includes a flow rate controller.

7. The substrate liquid processing apparatus of claim 4,
wherein after the second liquid is discharged from the second liquid discharge hole, the first liquid and the gas are discharged from the first liquid discharge hole and the gas discharge hole, respectively.

8. The substrate liquid processing apparatus of claim 4,
wherein the second liquid is discharged at a flow rate capable of preventing disturbance of a flow of the mixed fluid.

9. A substrate liquid processing method for performing a liquid process on a substrate by using a two-fluid nozzle that discharges a first liquid and a gas, mixes the discharged first liquid and the discharged gas at an outside of the two-fluid nozzle to generate a mixed fluid and discharges the mixed fluid toward a target spot on the substrate,
wherein a second liquid is supplied toward an outer periphery of the target spot on the substrate or toward an inner side of the outer periphery of the target spot.

10. The substrate liquid processing method of claim 9,
wherein the second liquid is supplied toward the outer periphery of the target spot on the substrate.

11. The substrate liquid processing method of claim 9,
wherein after the second liquid is discharged on the substrate, the mixed fluid is discharged on the substrate.

12. The substrate liquid processing method of claim 9,
wherein flow rates of the first liquid and the second liquid are controlled independently.

13. The substrate liquid processing method of claim 9,
wherein the second liquid is discharged at a flow rate capable of preventing disturbance of a flow of the mixed fluid.

14. A computer-readable storage medium having stored thereon computer-readable instructions that, in response to execution, cause a substrate liquid processing apparatus to perform a substrate liquid processing method for carrying out a liquid process on a substrate by using a two-fluid nozzle that discharges a first liquid and a gas, the substrate liquid processing method comprising:
mixing the discharged first liquid and the discharged gas at an outside of the two-fluid nozzle to generate a mixed fluid and discharging the mixed fluid toward a target spot on the substrate;
supplying a second liquid toward an outer periphery of the target spot on the substrate; and
moving a discharging position of the mixed fluid and a supplying position of the second liquid.
